(19) United States
(12) Patent Application Publication
(10) Pub. No.: US 2002/0044653 A1
(43) Pub. Date: Apr. 18, 2002

(54) Public-key encryption scheme for providng provable security based on computational Diffie-Hellman assumption

(76) Inventors: Joonsang Baek, Gyeonggi-Do (KR); Byoungcheon Lee, Daejeon (KR); Kwangjo Kim, Daejeon (KR)

Correspondence Address: BACON & THOMAS, PLLC, 625 Slaters Lane, 4th Floor, Alexandria, VA, 22314-1176, US

(21) Appl. No.: 09/825,976

(22) Filed: Apr. 5, 2001

(30) Foreign Application Priority Data
Oct. 17, 2000 (KR) 2000-60854

(51) Int. Cl. H04L 9/00

(52) U.S. Cl. 380/42; 713/168

(57) ABSTRACT

A public-key encryption scheme provides a provable security against adaptive-chosen-ciphertext-attacks (ACCA) and reduces the length of a ciphertext in a public-key encryption system. For the above purposes, the public-key encryption scheme is based on a weaker assumption, a computational Diffie-Hellman assumption (CDH-A) than a fundamental assumption, a decisional Diffie-Hellman assumption (DDH-A) and analyzes the security of the ciphertext in a random oracle model. Thus, the method guarantees provable security and length-efficiency.

### FIELD OF THE INVENTION

The present invention relates to a public-key encryption scheme for providing a provable security based on computational Diffie-Hellman assumption; and, more particularly, to a public-key encryption scheme for providing a provable security against adaptive-chosen-ciphertext-attacks and reducing the length of a ciphertext in a public-key encryption system.

### BACKGROUND OF THE INVENTION

The explosive growth of the communications network has made it possible to exchange messages, e.g., electronic mail (e-mail), electronic document, etc, having a variety of information on a global scale. Compared with a delivery by the Post Office, the messages reach the recipient much faster, and unlike telephone calls they do not tie the recipient down. For these reasons, e-mail is becoming very popular through the communications network as a way to distribute and exchange information efficiently.

However, when corporate users use e-mail and electronic document to exchange information with other users through the communications network, they may be exposing corporate secrets to eavesdropping or other illicit acts carried out by crackers, that is, malicious users with a great deal of knowledge about networks and communications who use their expertise to exploit weaknesses in the security of e-mail system and electronic document transmission system. One example is electronic eavesdropping. Messages are normally sent over the Internet without any kind of built-in encryption, so anyone who obtains the text of the message is able to read it. Another example is spoofing. A cracker can pretend to be another user and send a fictitious message under the user's name. A third example is tampering with the contents of actual messages. Like spoofing, this kind of manipulation is relatively easy for crackers to perform and the recipient of the message has no way to detect it.

But even though the recipient of a message cannot hear the sender's voice or see the sender's face, there are ways to protect the security of the information in the message. The first way is to encrypt the information so that no one other than the intended recipient can read it. Another way is to include information in the message that allows the recipient to check whether the message was really sent by the person claiming to have sent it and to detect any alteration to the contents of the message. This can be done by using encryption scheme. But for the sake of convenience as well as security, it would be desirable to protect messages without requiring major changes in existing networks, e-mail systems and electronic document transmission system.

There are two general types of encryption algorithms: symmetric and asymmetric. The symmetric key cryptosystem uses an identical key for encryption and decryption, while the asymmetric key cryptosystem is designed so that a key used for encryption, i.e., a public key, is different from a key used for decryption, i.e., a secret key. The asymmetric key cryptosystem is called a public-key cryptosystem because the encryption key can be made public: Any one can use the public key to encrypt a message, but only a person with the corresponding decryption key can decrypt the message.

Referring to FIG. 1, there is provided a block diagram of a public-key encryption system. The public-key encryption system includes an encryption block 10 for encrypting a plaintext and transmitting a ciphertext, a decryption block 20 for generating the plaintext from the ciphertext, a public-key directory 30 and a communications channel 50. The decryption block 20 computes a pair of keys, i.e., a public and a secret key. The public key is publicized in the public-key directory 30 and the secret key is securely stored in the decryption block 20.

The encryption block 10 encrypts a message or plaintext with the public key and transmits thus generated ciphertext to the decryption block 20 through the communications channel 50. The decryption block 20 decrypts the ciphertext provided from the encryption block 10 by using the secret key corresponding to the public key and recovers the original plaintext.

But, when the ciphertext is transmitted between the encryption block 10 and the decryption block 20, an attacker may attack the ciphertext over the insecure communications channel 50 intentionally. In the attack against the ciphertext, someone not legitimately involved in the communications may eavesdrop on some or all of the ciphertext and gains information on the plaintext and the secret key from the ciphertext. This is called a passive attack because the attacker just listens the ciphertext. Alternatively, an attacker could try to alter or modify the ciphertext to his or her own advantage. The attacker could pretend to be someone else, insert new messages in the ciphertext, delete existing messages, substitute one message for another, replay old messages, interrupt a transmission channel, or alter stored information in the ciphertext. These are called an active attack because they can actively intervene into the transmission channel and modify the transmitting message.

Active attackers may get partial information of the ciphertext, e.g., least significant bit of the plaintext. Therefore, the public-key encryption system has to provide semantic security against such attacks.

Since Diffie and Hellman had proposed the concept of public-key cryptosystem, extensive researches have been done in this field. In particular, the public-key encryption scheme proposed by ElGamal has attracted considerable attention. When ElGamal proposed his public-key encryption scheme, it was widely believed that the security of this scheme is based on the computational assumption called “Diffie-Hellman assumption”. Roughly speaking, the Diffie-Hellman assumption means that for a cyclic group G, an adversary who sees g^{x} and g^{y} cannot efficiently compute g^{xy}. Often, G is defined as a multiplicative group of a large prime modulo p, i.e., Z*ₚ where g is a generator and x,yεZ_{q}. Note here that q is a large prime such that q|p−1.

It may be true that the security of ElGamal encryption scheme depends on the Diffie-Hellman assumption since an adversary attacking this scheme cannot obtain a ciphertext (g^{x},mg^{xy}) of a message m without computing g_{xy}. However, indistinguishability, which has been accepted as a general security notion of encryption schemes, does not require the attacker to decrypt the whole message. In the notion of the indistinguishability, security of encryption scheme implies that the adversary cannot tell ciphertexts of two plaintext messages chosen by himself (or herself). Consequently, it seems that the security of ElGamal encryption should depend on some stronger assumption rather than the Diffie-Hellman assumption. In fact, Tsiounis and Yung showed that the security of ElGamal encryption scheme is not based on the Diffie-Hellman assumption but based on the stronger Decisional Diffie-Hellman assumption (DDH-A). DDH-A says that an adversary who sees two distributions (g^{x},g^{y}, g^{xy}) and (g^{x},g^{y},R), where R is a randomly chosen-string whose length is the same as g^{xy}, cannot distinguish these two distributions. Hence the Diffie-Hellman assumption is often called the computational Diffie-Hellman assumption (CDH-A) for the purpose of emphasizing an adversary's inability to compute the Diffie-Hellman key, g^{xy}. Hereinafter, the term CDH-A is used to refer to the Diffie-Hellman assumption.

Since Zheng and Seberry initiated a full-scale research on adaptive chosen-ciphertext attacks, the design of public-key encryption schemes has trended toward the prevention of these attacks. In the adaptive chosen-ciphertext attack, an adversary is permitted to access a decryption function on ciphertexts chosen after obtaining the challenge ciphertext, with the only restriction that the adversary may not ask for the decryption of the challenge ciphertext itself.

Public-key encryption schemes provably secure against the adaptive chosen-ciphertext attack proposed so far include the Cramer-Shoup scheme (based on the DDH-A), and the Fujisaki-Okamoto (F-O) scheme (based on the security of any semantically secure public-key encryption schemes). More recently, a general method for converting any partially trapdoor one-way function to the public-key encryption scheme that is provably secure against the chosen-ciphertext attack has been proposed by Pointcheval.

The Cramer-Shoup scheme is said to be unique since it does not impose any ideal assumption on the underlying hash function as other schemes do. Though the use of an ideal hash function model, i.e., a random oracle model, is still controversial, this paradigm often yields much more efficient schemes than those in the standard model.

The underlying computational assumption of Cramer-Shoup scheme is DDH-A, which is much stronger than CDH-A, though the random oracle model is not used in this scheme. The situation remains the same in the ElGamal version of the F-O scheme. However, underlying computational assumption of the ElGamal version of recent Pointcheval's scheme is CDH-A, which is weaker than DDH-A. One disadvantage of this scheme has a message expansion: To encrypt a message m, one must compute (g^{H(m∥s)},rX^{H(m∥s)}, G(r)⊕(m∥s)), where X(=g^{x}) is a public key, rεZ*ₚ and sεZ_{q} are appropriate length of random strings. p Here, both G and H are random oracles. Consequently, the length of a ciphertext is 1.5 times longer than that of the original ElGamal version of the F-O scheme.

### SUMMARY OF THE INVENTION

It is, therefore, an object of the present invention to provide a public-key encryption scheme capable of providing security against chosen-ciphertext attacks in a random oracle model with a length of ciphertext being reduced compared with the Pointcheval's scheme.

In accordance with the present invention, there is provided a method for use in a public-key encryption system, the encryption system having an encryption block encrypting a plaintext m of a length of k₁ to output a ciphertext (α, β) and a decryption block for decrypting the ciphertext (α,β) to provide the plaintext m, including the steps of: (a) choosing variables p, q and g as public-key parameters, wherein p is a large prime number of a length k, q is a large prime number dividing p−1 and g is a generator for a multiplicative group Z*ₚ, wherein Z*ₚ={g⁰,g¹, g² , . . . ,g^{q-1}}; (b) choosing and publishing a first hash function H, H:{0, 1}^{k}→Z_{q}, providing security against an adaptive-chosen-ciphertext-attack and a second hash function G, G:Z*ₚ→{0, 1}^{k}, providing security under a computational Diffie-Hellman assumption; (c) choosing and storing a secret key x satisfying xεZ_{q} based on the chosen public-key parameters p, q and g and generating a public key X (X=g^{x}), thereby publishing the public-key parameters p, q and g and the public key X; (d) encrypting the plaintext m by using the public key X, thereby generating the ciphertext (α,β); (e) verifying whether the ciphertext (α,β) is valid or not; and (f) if the ciphertext (α,β) is verified to be valid, decrypting the ciphertext (α,β) by using the secret key x to recover the plaintext m.

### BRIEF DESCRIPTION OF THE DRAWINGS

The above and other objects and features of the present invention will become apparent from the following description of preferred embodiments given in conjunction with the accompanying drawings, in which:

FIG. 1 shows a block diagram of the public-key encryption system using a conventional public-key encryption algorithm;

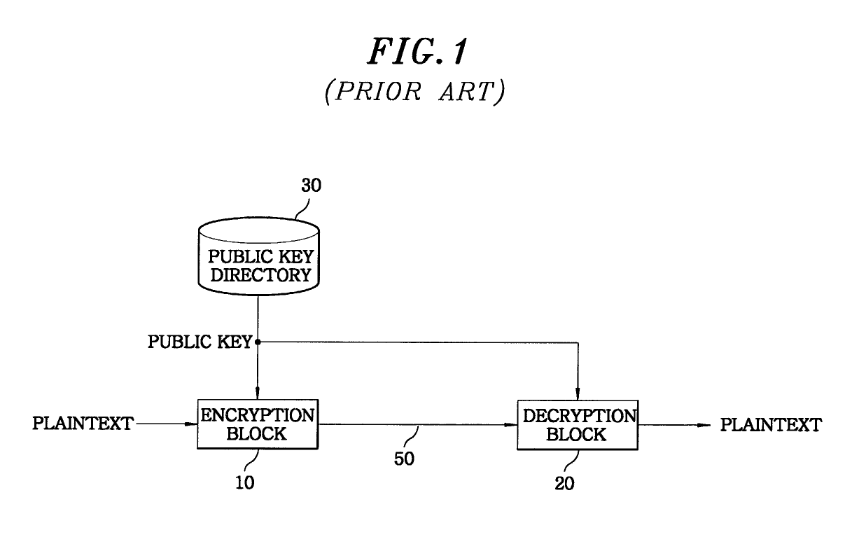

FIG. 2 presents a block diagram of a public-key encryption system in accordance with the present invention; and

FIG. 3 illustrates a flow chart of the public-key encryption scheme of the present invention.

### DETAILED DESCRIPTION OF THE PREFERRED EMBODIMENTS

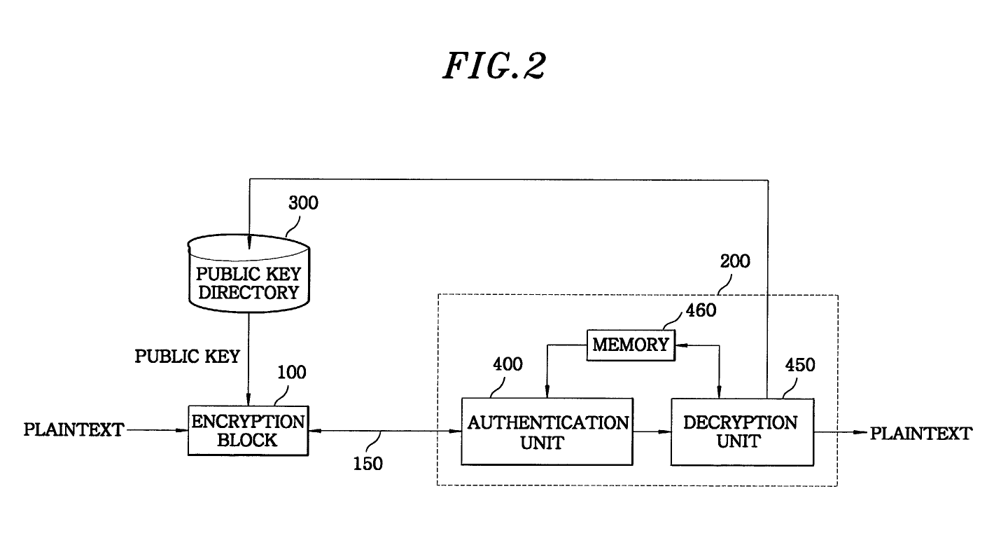

Referring to FIG. 2, there is provided a block diagram of a public-key encryption system in accordance with the present invention. The public-key encryption system comprises an encryption block 100, a communications channel 150, a decryption block 200, and a public-key directory 300, wherein the decryption block 200 includes an authentication unit 400, a decryption unit 450 and a memory 460.

The decryption unit 450 generates public-key parameters including large prime numbers p, q and a generator g. And, the decryption unit 450 generates a key pair of a randomly chosen secret key “x” and a public key “X(=g^{x})”. The public key parameters and the public key are stored in the public key directory 300 which is open to the public, and the secret key and the public key parameters are safely stored in the memory 460. The secret key should be protected from being accessed by adversaries. The public key generated is used to encrypt a plaintext at the encryption block 100 and the secret key is used to decrypt the encrypted plaintext, i.e., ciphertext, at the decryption block 200.

The encryption block 100 selects a random string r, encrypts the plaintext concatenated by the random string r and transmits thus generated ciphertext to the decryption block 200 over the communications channel 150.

The authentication unit 400 serves to examine whether the ciphertext has been attacked during a transmission. Specifically, the authentication unit 400 checks the validity of a transmitted ciphertext by using the secret key and makes the decryption unit 450 decrypt the ciphertext only if the ciphertext is valid. The decryption unit 450 decrypts the ciphertext to provide the original plaintext. If the ciphertext is determined to be invalid, the authentication unit 400 requests the encryption block 100 to transmit the ciphertext again.

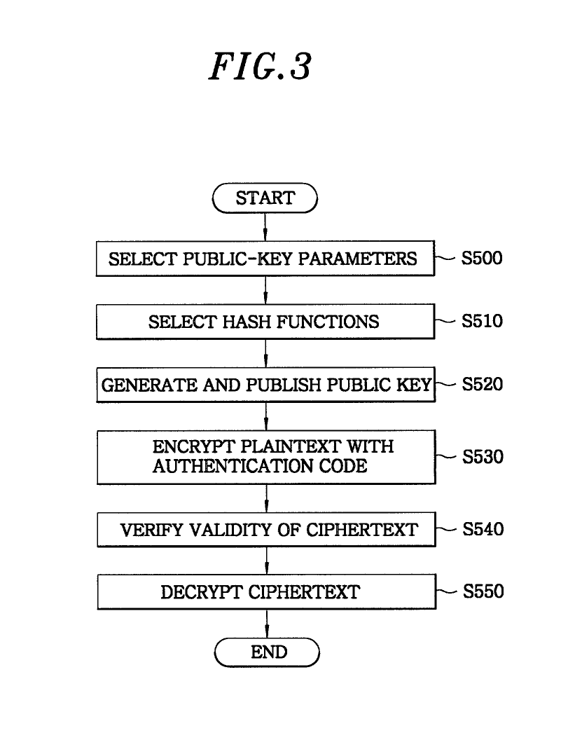

Referring to FIG. 3, there is provided a flow chart of the public-key encryption scheme in accordance with the present invention.

At step S500, the decryption unit 450 selects the public-key parameters, i.e., the large prime number p of a length k, the large prime number q dividing p−1 and the generator g of a multiplicative group Z, wherein the elements of Z*ₚ are {g⁰,g¹,g², . . . ,g^{q-1}}.

At step S510, the decryption unit 450 selects and publicizes hash functions H, G, i.e., two random oracles of H:{0, 1}^{k}→Z_{q} and G:Z*ₚ→{0, 1}^{k}. A hash function works like a function that takes a variable-length input string (called a pre-image) to return a fixed-length (generally smaller), e.g., 160 bit, output string (called a hash value). It is easy to compute a hash value from a pre-image, but it is computationally hard to find a pre-image for a given hashed value. These hash functions H and G are publicized system parameters to be shared by the encryption and the decryption blocks 100, 200. The conventional hash functions, e.g., MD5 and SHA-1, can be employed as the hash functions G and H.

Next, at step S520, after choosing x satisfying xεZ_{q} based on the chosen public key parameters p, q and g, the decryption unit 450 stores x as the secret key in the memory 460, computes the public key X satisfying XεZ*ₚ and publishes the public-key parameters p, q, g and the public key X in the public-key directory 300. The public key parameters may also be stored in the memory 460.

At step S530, the encryption block 100 encrypts the plaintext m having a length of k₀ bits to generate a ciphertext (α,β) by using the hash function H serving as a message authentication code capable of providing security against the ACCA (adaptive-chosen-ciphertext-attack); a random string r of length k₁ (k₀+k₁=k); the hash function G capable of providing security under CDH-A (computational Diffie-Hellman assumption); and the public key X retrieved from the public key directory 300. The ciphertext (α,β) can be defined as:

(α,β)=(g^{H(m∥r)}, G(X^{H(m∥r)}mod p)⊕(mλr)) Eq. 1

wherein m∥r represents the plaintext m concatenated by the random string r.

As can be seen in Eq. 1, the public-key encryption system capable of providing security under the CDH-A that is weaker than DDH-A can be achieved by applying the random oracle G to X^{H(m∥r)} in accordance with the present invention. The security against ACCA is ensured by providing the ciphertext (α,β) with an authentication code represented by the term g^{H(m∥r)}. Thus generated ciphertext (α,β) is transmitted to the decryption block 200 of the receiving part over the communications channel 150.

At step S540, in order to verify the validity of the ciphertext (α,β) transmitted from the encryption block 100, the authentication unit 400 calculates t a verification parameter for verifying the validity of the ciphertext, based on the variants α, β of the ciphertext and the secret key x. The verification parameter t can be defined as:

t=G(α^{x})⊕β Eq.2

Thereafter, the authentication unit 400 calculates a verification function g^{H(T)} and compares it with α of the ciphertext transmitted. If α is not identical to the verification function, the authentication unit 400 determines that the ciphertext (α,β) transmitted from the encryption block 100 is invalid, disregards the transmitted ciphertext and requests the encryption block 100 to retransmit the ciphertext.

However, if α is identical to the verification function, the decryption unit 450 recovers the plaintext m having the length of k₀ by removing the random string r of length k₁ from the verification parameter t, the random string r being concatenated to a tail part of the verification value t.

Meanwhile, this invention can be extended to Elliptic curve based schemes where all the exponentiation operations in eq. 1 and eq. 2 are replaced by addition operations over elliptic curve group.

While the invention has been shown and described with respect to the preferred embodiments, it will be understood by those skilled in the art that various changes and modifications may be made without departing from the spirit and scope of the invention as defined in the following claims.

What is claimed is:

1. A method for use in a public-key encryption system, the encryption system having an encryption block encrypting a plaintext m of a length of k₀ to output a ciphertext (α,β) and a decryption block for decrypting the ciphertext (α,β) to provide the plaintext m, comprising the steps of:
(a) choosing variables p, q and g as public-key parameters, wherein p is a large prime number of length k, q is a large prime number dividing p−1 and g is a generator for a multiplicative group Z*ₚ, wherein Z*ₚ={g⁰g¹,g² , . . . g^{q-1}};
(b) choosing and publishing a first hash function H, H:{0, 1}^{k}→Z_{q}, providing security against an adaptive-chosen-ciphertext-attack and a second hash function G, G:Z*ₚ→{0, 1}^{k}, providing security under a computational Diffie-Hellman assumption;
(c) choosing and storing a secret key x satisfying XεZ_{q} based on the chosen public-key parameters p, q and g and generating a public key X (X=g^{x}), thereby publishing the public-key parameters p, q and g and the public key X;
(d) encrypting the plaintext m by using the public key X, thereby generating the ciphertext (α,β);
(e) verifying whether the ciphertext (α,β) is valid or not; and
(f) if the ciphertext (α,β) is verified to be valid, decrypting the ciphertext (α,β) by using the secret key x to recover the plaintext m.

2. The method of claim 1, wherein the ciphertext (α,β) is defined as:
(α,β)=(g^{H(∥r)}, G(X^{H(m∥r)}mod p)⊕(m∥r))
where r is a random string of a length k₁ with k₀+k₁=k.

3. The method of claim 2, wherein the verifying step (e) includes the step of (e1) computing t=G(α^{x})⊕β and determining whether α of the ciphertext (α,β) is identical to g^{H(t)} or not.

4. The method of claim 3, wherein the decrypting step (f) includes the step of removing the random number r from t to thereby recover the plaintext m.

5. The method of claim 2, wherein the exponentiation operation is replaced by addition operation over elliptic curve group.
